(19) United States
(12) Patent Application Publication
(10) Pub. No.: US 2024/0072497 A1
(43) Pub. Date: Feb. 29, 2024

(54) PERPENDICULARLY MOUNTED NETWORK JACK WITH SECURE CONNECTOR AND MAGNETICS

(71) Applicant: XFMRS, INC., Camby, IN (US)

(72) Inventors: Weijia Kong, ZhongShan City (CN); Yukun Liao, ZhongShan City (CN); Liang Huang, ZhongShan City (CN); Buddy Woods, Camby, IN (US)

(21) Appl. No.: 17/766,521

(22) PCT Filed: Oct. 2, 2020
(86) PCT No.: PCT/US2020/054056

§ 371 Date: Apr. 4, 2022

Related U.S. Application Data
(60) Provisional application No. 62/910,740, filed on Oct. 4, 2019.

(51) Int. Cl. H01R 13/719; H01R 13/6581

(52) U.S. Cl. CPC H01R 13/719; H01R 13/6581

(57) ABSTRACT

A network jack has a connector, a housing and a plurality of magnetic circuit elements. The connector has a first end, a second end, and at least four walls. The four walls extend from the first end to the second end in a first direction and are disposed about a bar. The bar has conductive contacts thereon and is spaced apart from the four walls. The housing has sides extending in the first direction from a top edge to a bottom panel. The housing includes an interior defined between the top edge and the bottom panel, the top edge operably coupled adjacent the second end of the connector. The plurality of leads extend from the bottom panel. The magnetic circuit elements are disposed in the interior of the housing and operably coupled to the plurality of leads and at least a first of the conductive contacts on the bar.

This application claims the benefit of U.S. Provisional Patent Application Ser. No. 62/910,740, filed Oct. 4, 2020.

### TECHNICAL FIELD OF THE INVENTION

The present invention relates generally to network jack assemblies, and more specifically to a network jack having a built-in transformer circuitry.

### BACKGROUND ART

High speed communications boards typically incorporate various kinds of connectors by which telecommunications equipment are connected. One kind of connector is an IEC 60603-7 8P8C standard connector, which is commonly called an RJ-45 connector, used for high speed network communications. Typical high speed applications include networks such as Ethernet operating over a 10BASE-T, 100BASE-T lines, 1000BASE-T, as well as others.

A full 8P8C connection consists of a male plug and a female jack, each with eight equally-spaced contacts. On the plug, the contacts are flat metal strips positioned parallel to the connector body. Inside the jack, the contacts are metal spring wires arranged at an angle toward the insertion interface. When the plug is mated with the jack, the contacts meet and create an electrical connection. The spring tension of the jack contacts creates the interface. The housing can include a single spring loaded, thumb operated retention mechanism. Such connectors are ubiquitous in local area network environments.

The 8P8C connection suffers from the drawback in that the connectors can be damaged and or dislodged by inadvertent impact and/or stress. To address these issues, a new Ethernet connection system has been developed that incorporates a more robust physical connection, and one with a reduced footprint. This system, based on the standard IEC/PAS 620176-3-124, is available from Hirose Electric Co., Ltd. and Harting Industrial under the registered trademark ix Industrial®. The Harting system includes a jack that has a central bar with vertically spaced connector on each side of the central bar. The central bar is surrounded by the receptacle housing. The corresponding plug has a base that encloses the wire terminations and supports and reinforces the insertable plug portion. The base has a width and height that exceeds the height and width of the insertable plug portion.

The insertable plug portion is received within the receptacle housing of the jack such that it surrounds the central bar. The contacts of the plug engage and electrically connect with the contacts on the central bar. The base of the corresponding plug includes an actuator for controllably retracting a detent on the insertable plug portion. The detent is configured to retain the plug within the receptacle housing. The jack includes traces that provide a direct conductive connection from each of the vertical space connectors to a corresponding pin that is mountable on a circuit board.

Even though the Harting system employs shielded jacks to limit EMI, the devices still can be subject to cross-coupling of the radiation between adjacent pins, or on the traces of the circuit board to which they are mounted. In addition, digital transmissions generally are sensitive to noise artifacts. For these reasons, high speed communications boards usually include various filtering components in order to minimize unwanted cross-talk and provide the required isolation between the user and the line and filtering of undesirable noise to allow only the necessary frequency bandwidth to pass for accurate communication.

Noise suppressors, such as a common mode choke coil, are known in the art. The noise suppression circuitry is typically mounted on the PC motherboard and is connected in series with a network jack, which is also mounted to the PC board. However, such signal conditioning devices consume board real estate, which could otherwise be used to mount additional circuitry. The current jack design for use in the available systems implementing the IEC/PAS 61076-3-124 standard is designed for minimal size, and does not contain any room for additional components.

What is needed is a jack design for available plugs implementing IEC/PAS 61076-3-124 that avoids the problems associated noise and crosstalk without detracting from the miniaturization advantages enabled by the standard.

### SUMMARY

At least some embodiments described herein address the problems by implementing a network jack that incorporates signal conditioning circuit in a way that conserves circuit board space.

A first embodiment is a network jack having a connector, a housing and a plurality of magnetic circuit elements. The connector has a first end, a second end, and at least four walls. The four walls extend from the first end to the second end in a first direction and are disposed about a bar. The bar has linear conductive contacts thereon and is spaced apart from the four walls. The housing has a plurality of sides extending in the first direction from a top edge to a bottom panel opposite the top edge. The housing includes an interior defined between the top edge and the bottom panel, the top edge operably coupled adjacent the second end of the connector. The plurality of leads extend from the bottom panel. The magnetic circuit elements are disposed in the interior of the housing and operably coupled to the plurality of leads and at least a first of the plurality of linear conductive contacts on the bar.

Another embodiment is a network jack that includes a connector, a housing, a plurality of magnetic circuit elements, and a shielding cap. The connector has a first end, a second end, and at least four walls. The four walls extend from the first end to the second end and are disposed about a bar. The bar has conductive contacts thereon and is bar spaced apart from the four walls. The housing is operably coupled adjacent the second end of the connector and has an interior and a plurality of leads. The magnetic circuit elements are disposed in the interior and are operably coupled to the plurality of leads and at least a first of the plurality of conductive contacts on the bar. The shielding cap is disposed about the second end of the connector and engages the housing.

The above-described features and advantages, as well as others, will become more readily apparent to those of ordinary skill in the art by reference to the following detailed description and accompanying drawings.

### BRIEF DESCRIPTION OF THE DRAWINGS

FIG. 1 shows a perspective view of a network jack according to a first embodiment;

FIG. 2 shows a perspective view of a prior art plug for use with the network jack of FIG. 1;

FIG. 3 shows a side plan view of the prior art plug of FIG. 2 inserted, or plugged into, the network jack of FIG. 1;

FIG. 4 shows a bottom plan view of the network jack of FIG. 1;

FIG. 5 shows a top plan view of the network jack of FIG. 1;

FIG. 6 shows an exploded perspective view of a connector of the network jack of FIG. 1;

FIG. 7 shows a perspective view of the connector of FIG. 6;

FIG. 8 shows an exploded perspective view of the housing, a plurality of circuit elements and a circuit board of the network jack of FIG. 1;

FIG. 9 shows a perspective view of a subassembly of the connector, a circuit board and the main housing of the network jack of FIG. 1;

FIG. 10 shows a perspective view of a cap of the network jack of FIG. 1;

FIG. 11 shows a perspective view of a metal clip of the network jack of FIG. 1;

FIG. 12 shows a schematic diagram of an exemplary conditioning circuit that may be used in the network jack of FIG. 1.

### DETAILED DESCRIPTION

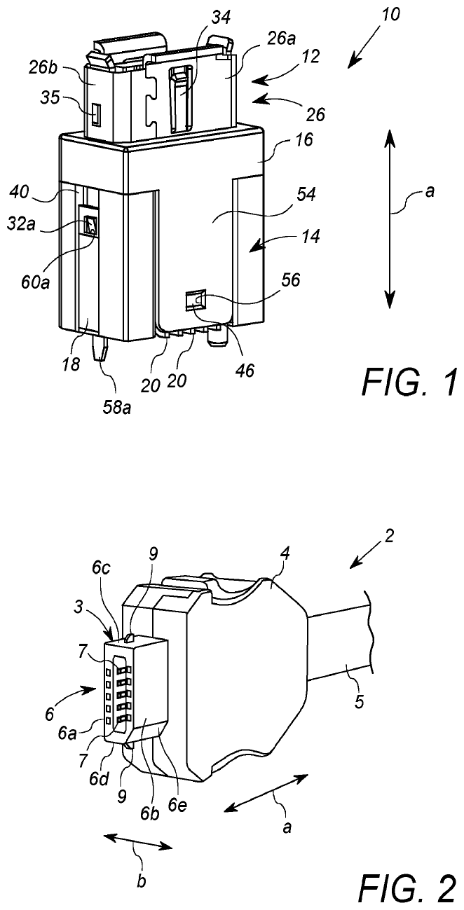

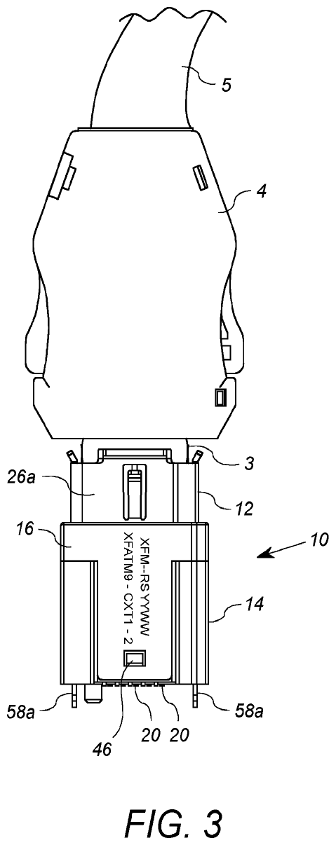

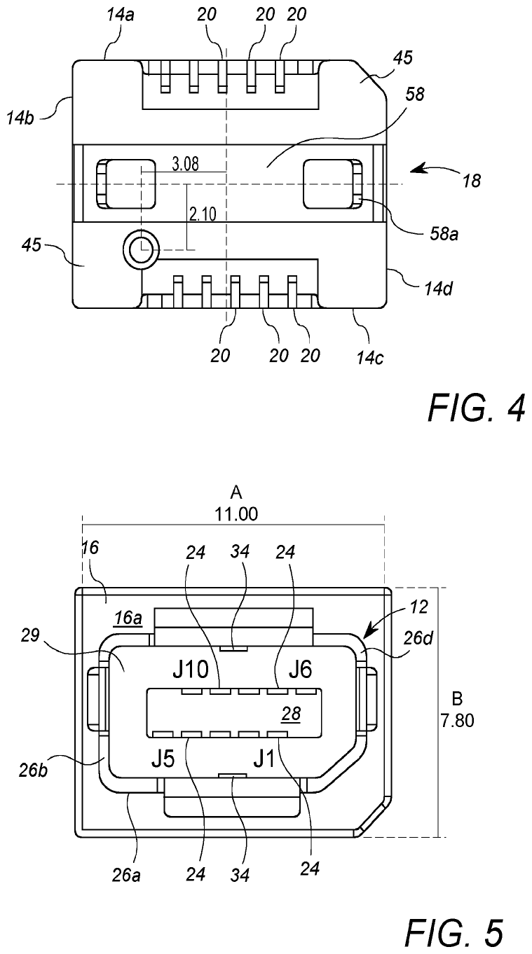

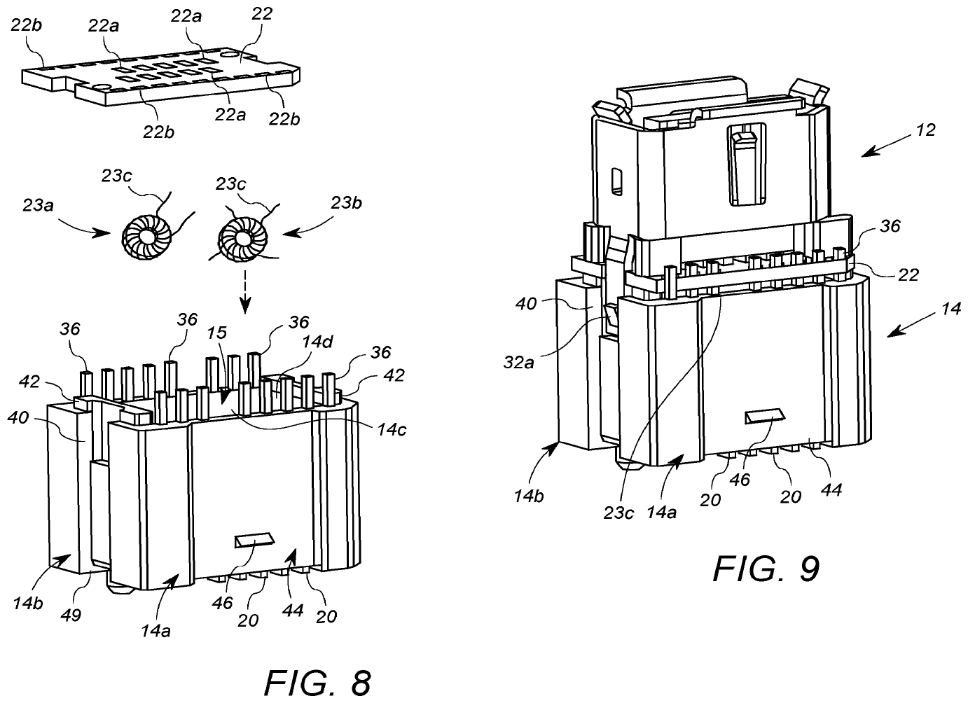

FIG. 1 shows a perspective view of a network jack 10 according to a first embodiment. The network jack 10 includes a connector 12, a housing 14, a cap 16, a clip 18, and a plurality of leads 20. The network jack 10 also includes a circuit board 22 and a plurality of magnetic circuit components 23a, 23b, not shown in FIG. 1, but shown in FIG. 8, discussed further below. FIG. 2 shows a perspective view of a cooperating prior art plug 2. FIG. 3 shows a side plan view of the prior art plug 2 inserted, or plugged into, the network jack 10. FIG. 4 shows a bottom plan view of the network jack 10, and FIG. 5 shows a top plan view of the network jack 10.

FIG. 1 shows the jack 10 in its normal position that extends vertically upward from (i.e. perpendicular to) a horizontally oriented circuit board or housing not shown. It will be appreciated that the terms horizontal and vertical are intended to be relative, and are used for convenience under the assumption that the printed circuit board on which the jack 10 is mounted, is disposed in a horizontally. The plug 2 is shown extending horizontally, and would be rotated 90 degrees counterclockwise to connect to the jack 10, as shown in FIG. 3.

With reference to FIGS. 2 and 3, the plug 2 may suitably be the ix Industrial® plug available from Hirose Electric Company, Ltd., and includes a plug portion 3 and a case 4. The plug portion 3 extends outward (in the plugging direction a) from the case 4. The case 4 houses the terminations of the conductors within a network cable 5. The plug portion 3 includes a metal frame 6 having opposing side walls 6a, 6b, and top and bottom walls 6c, 6d, generally arranged as a rectangular structure, but having a chamfered edge 6e on one corner. The plug portion 3 also includes a plurality of conductive contacts in the form of metal conductive strips 7 that extend along the plugging direction a. More specifically, one set of the conductive strips 7 is disposed on a plate proximate to the first side wall 6a. Such strips 7 are disposed parallel to and spaced apart from each other, and face the opposing side wall 6b. The other set of the conductive strips 7 is disposed on another plate proximate to the second side wall 6b. Such strips 7 are similarly disposed parallel to and spaced apart from each other, and face the opposing side wall 6a.

The case 4 has a lateral width (in direction b perpendicular to the plugging direction a) that exceeds the lateral width of the plug portion 3, i.e. the distance between the outer surfaces of the side walls 6a, 6b. In this embodiment, the case 4 has a lateral width of approximately 10 mm and the plug portion has a lateral width of approximate 4 to 4.5 mm. The width of the case 4 exceeds the width of the plug to, among other things, accommodate the wire terminations from the cable 5.

In this embodiment, the network jack 10 is configured to securely receive the plug portion 3 and provide electrical connection from the metal conductive strips 7 to the leads 20. The leads 20 in this embodiment are surface mount leads that extend along a bottom surface of the network jack 10 to conserve footprint. However, it will be appreciated that the leads 20 may take the form of other surface mount or other type of lead configured to electrically and physically connect to, for example, a printed wiring board, not shown.

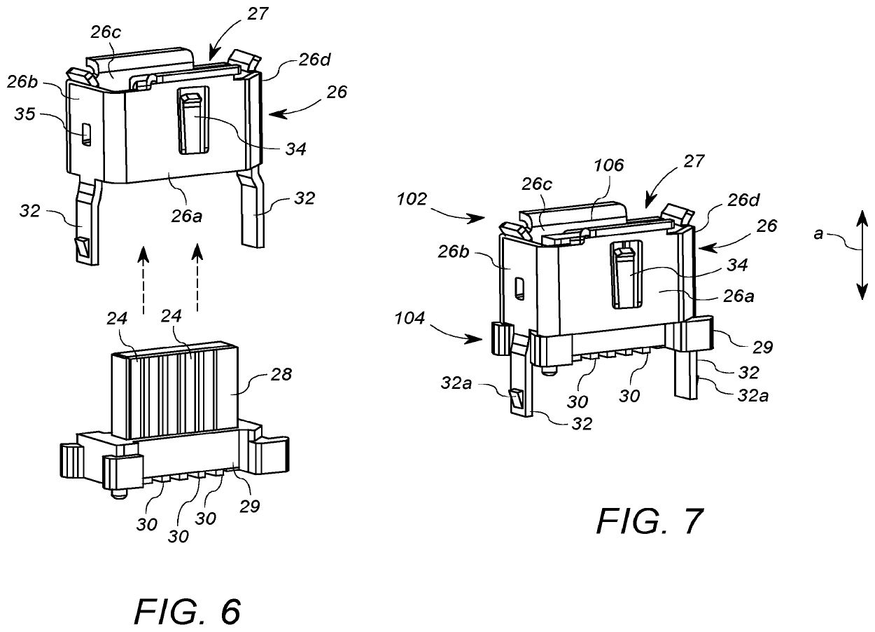

FIG. 6 shows an exploded perspective view of the connector 12, and FIG. 7 shows a perspective view of the connector 12. With reference to FIGS. 1, 3, 5, 6 and 7, the connector 12 is configured to receive and connect to the plug portion 3, such that Ethernet network signals are between the plug portion 3 and the connector 12. The connector 12 includes a plurality of conductive contacts or leads 24 and a connector housing 26. The plurality of conductive leads 24 (FIGS. 5, 6) are disposed in a parallel adjacent manner and on opposite surfaces of a central bar 28. The central bar 28 is affixed (and integrally formed with a platform 29. Plural connector terminals 30, electrically connected to the conductive leads 24, are formed with and extend through the platform 29, and form the path through which signals from the plug 3 in the connector 12 are communicated through the connector 12.

The connector housing 26 is formed by the platform 29 and four walls, and extends in the plugging direction a from a first end 102 to a second end 104. The first end 102 includes the opening 106 through which the plug 3 is inserted, and the second end (end region) 104 is defined in part by the platform 29. The four walls include two side walls 26a, 26c and two end walls 26c, 26d that extend in the first direction from a first end 102 to the second end 104, where they engage features of the platform 29. The walls 26a, 26b, 26c, and 26d define an interior 27 above the platform 29. The central bar 28 is disposed in the interior 27, and is spaced part from each of plurality of walls 26a, 26b, 26c and 26d of the connector housing 26. The walls 26a, 26b, 26c and 26d of the connector housing 26 are connected to the platform 29 to provide a consistent location of the central bar 28 and conductive leads 24 within the interior of the housing 26. In this embodiment, the platform 29 and the central bar 28 may be integrally formed of molded polymer. In any event, the central bar 28 and the platform 29 are formed of a non-conductive polymer.

The connector housing 26 includes spring features 34 on the opposing side walls 26a and 26c to assist in biasing the plug 2 into position. The opposing end walls 26b, 26d of the connector housing 26 also include through holes 35 that are configured to cooperate with corresponding retractable detents 9 on the plug 2 to secure the plug 2 in an operably connected position. Extending outward and downward from the end walls 26b, 26d of the housing 26 are conductive side wings 32, which have detents 32a. The side wings 32 extend below and beyond the second end 104 of the connector housing 26. The four walls 26a, 26b, 26c and 26d of the connector housing 26 may suitably be formed from a metal shielding material.

Discussion of the main housing 14 of the network jack 10 is made with additional reference to FIGS. 8 and 9. FIG. 8 shows an exploded perspective view of the housing 14, a plurality of circuit element 23a, 23b, and a circuit board 22. FIG. 9 shows a perspective view of the connector 26, the circuit board 22 and the main housing 14 assembled together without the cap 16. With reference to FIGS. 1, 4, 8 and 9, the main housing 14 is an open top container formed of a bottom panel 45 and a plurality of sides 14a, 14b, 14c, and 14d that extend from a top edge 14e to the bottom panel 45. The housing 14 is coupled adjacent the second end 104 of the connector 26, as shown in FIG. 9. In other words, the housing 14 is disposed below and supports the connector housing 26.

In this embodiment, the surface mount pins 20 are molded into the bottom panel 45 the main housing 14 at the bottom thereof. In addition, tie off pins 36 are molded into the top of the housing 14 and extend out of the top edge 14e. At least some of the tie off pins 36 are electrically coupled to corresponding surface mount pins 20 via conductors molded into or on the housing 26. The side walls 14a, 14c of the housing 14 have an indented portion 44 in the form a a vertical channel. The indented portion 44 includes a snap fit connector in the form of a detent 46 configured to engage a corresponding feature on the cap 16, discussed further below. The end walls 14b, 14d have an indented portion or channel 40 for receiving the clip 18 and the wings 32 of the connector 12, as shown in FIG. 9, for example. The end walls 14b and 14d also include a pedestal that extends above the top edge 14e. The side walls 14a, 14c and the end walls 14b, 14d cooperate with a bottom wall 45 to define an interior 15 in which toroids 23a, 23b, as well as transformers, and/or other circuit components, are be disposed. The bottom wall 45 also includes a central depression or channel 49 for receiving a long bar 58 of the clip 18, discussed further below.

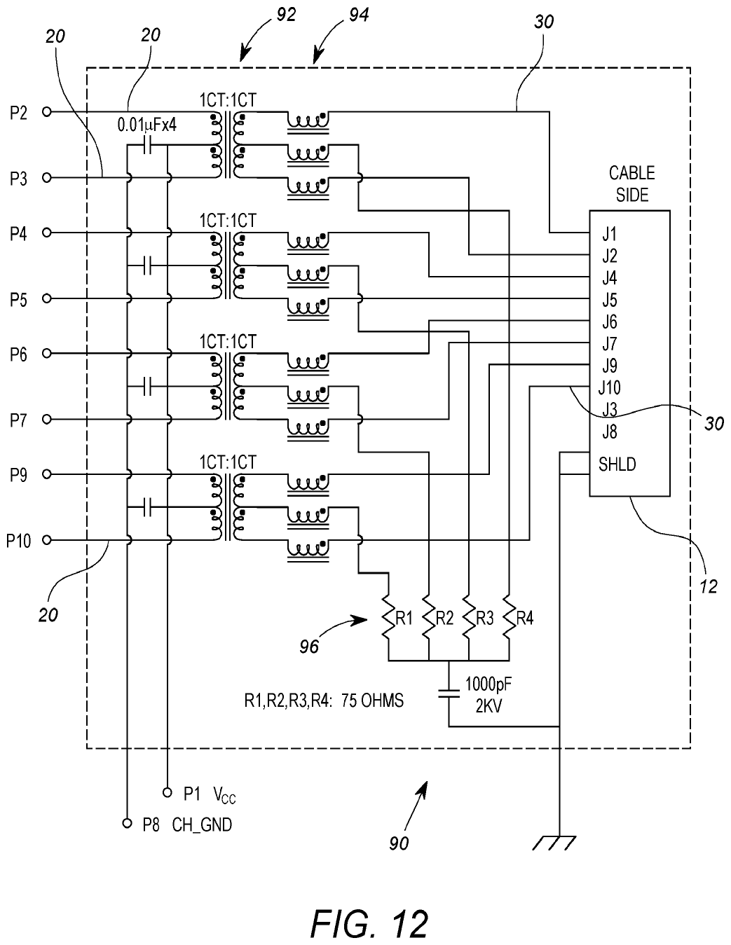

The circuit board 22 includes lands 22a for physically and electrically connecting to the pins 30 of the connector 12, and further includes holes 22b for receiving tie off pins 36. The circuit board 22 is electrically connected to the toroids 23a, 23b disposed in the interior 15, and is connected to other circuit elements, not shown, but discussed below in connection with FIG. 12. The circuit board 22 extends over the tie off pins 36 and engages the pedestals 42 of the end walls 14b, 14d. In this manner, a portion of the tie off pins 36 is exposed below the circuit board 22 to allow wires 23c of the components 23a, 23b to be tied off to the pins 36 before the circuit board 22 is mounted. The wires 23c thus are tied off to the pins 36 between the circuit board 22 and the top edge 14e of the housing 14. The circuit board 22 includes suitable conductive traces that carry out the circuit connections between components as shown below schematically in FIG. 12.

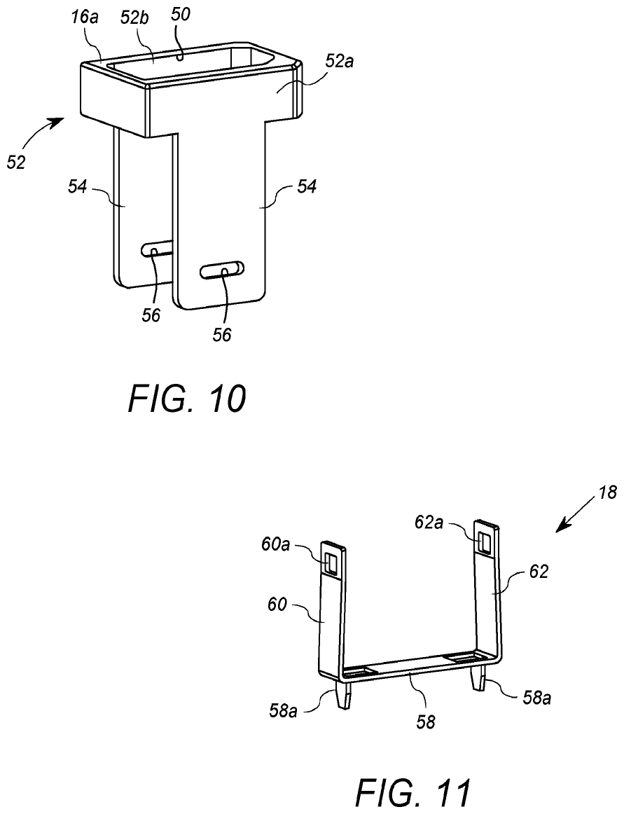

FIG. 10 shows a perspective view of the cap 16 apart from the network jack 10. With reference to FIGS. 1, 8, and 10, the cap 16, which may be made of a metal shielding material, roughly defines an open bottom cap 52 with a top wall 16a having an opening 50. The opening 50 has a shape that corresponds with the cross section of the connector 12 to allow the four walls 26a, 26b, 26c and 26d of the connector 12 to extend therethrough, as shown in FIG. 1. The side walls 52a, 52b of the cap 52 include extensions 54 having a snap fit connector in the form of opening 56. As best illustrated by FIGS. 1 and 8, the cap 16 fits onto housing 14 with the extensions 54 fitting into the corresponding indentations 44 in the side walls 14a, 14c. The connector 46 of the housing 14 snap fits into the corresponding connector (opening 56) of the extension 54 to secure the cap 16 onto the housing 14. The cap 16 is placed onto the housing 14 with the connector 12 in place by positioning the top opening 50 such that the connector 12 passes through as the cap 16 is moved toward the housing 14. The cap 16 is conductive and extends around the circuit board 22 and tie off pins 36 to provide a shielding function. When the cap is in place the conductive bars

FIG. 11 shows a perspective view of the metal clip 18. The clip is U-shaped, having a bottom horizontal long bar 58 and two vertical bars 60, 62 extending from opposing ends thereof. The bars 60, 62 are configured to fit into the channels 40 of the end walls 14b, 14d of the housing 14. Each of the vertical bars 60, 62 includes a coupler 60a, 62a in the form of a receiver for receiving the detent on the wings 32 of the connector 12. The long bar 58 includes conductive posts 58a extending downward therefrom.

In the final assembly of FIG. 1, as discussed above, the circuit board 22 engages the tie off pins 36, and the platform 29 of the connector 12 is disposed on the circuit board 22 such that the pins 30 engage the lands 22a. (See also FIGS. 8 and 9). The cap 16 is disposed about the second end 104 of the connector 12 and engaging the housing 14, and the four walls 26a, 26b, 26c and 26d extend through the opening 50 of the cap 16. In this way, the cap 16 provides shielding to the exposed circuit areas which can be seen in FIG. 9, where the cap 16 is not present. Referring again to FIG. 1, the conductive side wings 32 extend downward past the cap 16 in the channel 40, such that the detent 32a is below the cap 16. The vertical bars 60, 62 of the clip 18 extends upward in the channel 40. The detent 32a couples to a corresponding coupling 60a on the clip 18. As discussed above and shown in FIG. 4, the long bar 58 of the clip 18 seats into the indentation 49 on the bottom wall 45. The posts 58a can be used to connect to a ground connection of an external board. So connected, there is electrical continuity between the posts 58a and the connector housing 26.

As discussed above, the circuit board 22 is coupled to the magnetic circuit elements 23a, 23b, as well a plurality of other circuit elements, not shown, forming a signal conditioning circuit, which forms the electrical circuit between the pins 30 on the bottom of the connector 12 and the surface mount pins 20 on the bottom of the housing 14. The signal conditioning circuit 90 can take a plurality of known forms used process Ethernet signals received on an Ethernet cable to signals for use by a data receiving circuit. Such a circuit can include one or more chokes and/or transformers, such as the toroids 23a, 23b of FIG. 8. Such chokes or transformers, may be mounted on the circuit board 22, or otherwise secured in the interior 15, and are connected via traces, wires, pins 36 and/or possibly other elements, not shown, to the pins 20 and 30. FIG. 12 shows a schematic of an exemplary conditioning circuit 90 that may be used in the network jack 10 and disposed within the interior 15 of the housing 14. The conditioning circuit includes isolation transformers 92. Each of the isolation transformers 92 is a center tap transformer having a respective primary winding electrically connected to corresponding pins 20, and a respective secondary winding. Each of the secondary windings is operably coupled to corresponding pins 30 via a corresponding three wire common-mode choke 94. Each is of the secondary windings furthermore has a center tap connection to a filter 96 or Bob Smith termination, which is further operably coupled to corresponding pins 58. The filter 96 in this embodiment includes four resistors R1, R2, R3 and R4 all having one end connected to a 1000 pF capacitor, which is further coupled to ground. The other ends of resistors R1 and R2 are coupled to the center taps of respective secondary winding via the respective common mode choke 94, and the other ends of resistors R3 and R4 are coupled to corresponding pins 30. While the above circuit represents a conditioning circuit suitable for 10/100 Ethernet connections, many other variants of Ethernet conditioning circuits may be used, including those that support PoE and gigabit Ethernet.

One of the advantages of the embodiments described herein is that the magnetic circuit elements of the conditioning circuit 90 (and variants thereof) are disposed within the main housing 14, with little or no sacrifice of usage of external circuit board space beyond that normally used for a similar connector without conditioning elements.

To this end, it will be appreciated that the main housing 14 and cap 16 have a width that is approximately equal to a width of the case 4 of the plug 2, for example, approximately 9-10 mm. As a result, the minimum spacing between the jack 10 and similar outer housings of adjacent jacks (having the design of the jack 10) is the same as prior art devices. Specifically, in the prior art devices, the minimum spacing between jacks was defined by the width of the plug 2, and specifically, the case 4. In the embodiment described herein, the width of the jack 10 is increased to the same width as the case 4 to accommodate additional circuitry within the case, while not requiring any larger footprint.

It will be appreciated that the above-described embodiments are merely exemplary, and that those of ordinary skill in the art may readily devise their own implementations and modifications that incorporate the principles of the present invention and fall within the spirit and scope thereof.

1. A network jack comprising:
a connector having a first end, a second end, and at least four walls extending from the first end to the second end in a first direction and disposed about a bar, the bar having a plurality of conductive contacts thereon, the bar spaced apart from the four walls;
a housing having a plurality of sides extending in the first direction from a top edge to a bottom panel opposite the top edge, the housing including an interior defined between the top edge and the bottom panel, the top edge operably coupled adjacent the second end of the connector, the housing further comprising a plurality of leads extending from the bottom panel;
a plurality of magnetic circuit elements disposed in the interior of the housing and operably coupled to the plurality of leads and at least a first of the plurality of conductive contacts on the bar.

2. The network jack of claim 1, further comprising a circuit board interposed between the connector and the housing.

3. The network jack of claim 2, wherein the housing further comprise a plurality of pins extending from the top edge of the housing through the circuit board.

4. The network jack of claim 3, further comprising a signal conditioning circuit electrically coupled to the circuit board, the signal conditioning circuit including the plurality of magnetic circuit elements.

5. The network jack of claim 2, further comprising a shielding cap disposed about the second end of the connector and the circuit board, the shielding cap engaging the housing.

6. The network jack of claim 1, wherein at least a first element of the plurality of magnetic circuit elements comprises an isolation transformer.

7. The network jack of claim 1, wherein at least a first element of the plurality of magnetic circuit elements comprises a common mode choke.

8. The network jack of claim 1, wherein the connector further comprises first and second conductive bars, each of the first and second conductive bars extending in the first direction on the housing.

9. The network jack of claim 8, further comprising a spring clip having first and second conductive terminals extending along the housing, each of the first and second conductive terminals physically connected to a respective one of the first and second conductive bars.

10. The network jack of claim 9, wherein the spring clip extends between the first and second conductive terminals along the bottom panel of the housing, and wherein the spring clip includes at least one lead extending in the first direction away from the bottom panel of the housing.

11. The network jack of claim 1, wherein the housing comprises first and second opposing sides and third and fourth opposing sides extending from the top edge to the bottom panel.

12. The network jack of claim 11 wherein the connector further comprises first and second conductive bars, the first conductive bar extending on third side the housing, and the second conductive bar extending on the fourth side of the housing.

13. The network jack of claim 12, wherein the third side of the housing includes a channel, and wherein the first conductive bar extends on the third side of the housing within the channel.

14. A network jack comprising:
a connector having a first end, a second end, and at least four walls extending from the first end to the second end and disposed about a bar, the bar having a plurality of conductive contacts thereon, the bar spaced apart from the four walls;
a housing operably coupled adjacent the second end of the connector and having an interior and a plurality of leads;
a plurality of magnetic circuit elements disposed in the interior and operably coupled to the plurality of leads and at least a first of the plurality of conductive contacts on the bar;
a shielding cap disposed about the second end of the connector and engaging the housing.

15. The network jack of claim 14, wherein the four walls of the connector extend through an opening in the shielding cap.

16. The network jack of claim 15, wherein the housing includes at least a first snap fit connector formed on a side thereof, and wherein the shielding cap includes at least a corresponding snap fit connector feature configured to engage the first snap fit connector to retain the shielding cap on the housing.

17. The network jack of claim 1, wherein the housing comprises first and second opposing sides, and third and fourth opposing sides, the first, second, third and fourth sides extending from the top edge to the bottom panel.

18. The network jack of claim 17, wherein the housing includes at least a first snap fit connector formed on each of the first side and the second side, and wherein the shielding cap includes corresponding snap fit connectors configured to engage the first snap fit connectors to retain the shielding cap on the housing.

19. The network jack of the claim 18, wherein the first side of the housing includes a recess, and wherein the first snap fit connector of the first side is disposed in the recess.
